(19) United States
(12) Patent Application Publication
(10) Pub. No.: US 2008/0295415 A1
(43) Pub. Date: Dec. 4, 2008

(54) Motor Vehicle Door

(76) Inventors: Hans-Helmut Mieglitz, Monheim (DE); Thorsten Meyer, Krefeld (DE)

Correspondence Address: DICKINSON WRIGHT PLLC, 1901 L. STREET NW, SUITE 800, WASHINGTON, DC, 20036, US

(21) Appl. No.: 12/066,283

(22) PCT Filed: Aug. 23, 2006
(86) PCT No.: PCT/EP2006/008284

§ 371 Date: Jul. 25, 2008

(30) Foreign Application Priority Data
Sep. 9, 2005 (DE) 10 2005 043 183.6

(51) Int. Cl. B60J 5/04

(52) U.S. Cl. 49/502

(57) ABSTRACT

The invention relates to a motor vehicle door (1), the interior of which is divided by a partition (6) into an outer wet space (7) facing the chassis (3) and an inner dry space (8) facing the door trim (2, 2.1), comprising a seal region (14) within which the partition (6) is held between the chassis (3) and the door trim (2, 2.1), with at least one spring-like device (10, 12, 15) arranged in the seal region (14).

### CROSS REFERENCE TO RELATED APPLICATIONS

None.

### BACKGROUND OF THE INVENTION

1. Field of the Invention

The present invention relates to a vehicle door, the interior thereof being subdivided by a separating means into an external wet space facing the body and into an internal dry space facing the door lining and which comprises a sealing region, within which the separating means is clamped between the body and the door lining.

2. Related Art

Such vehicle doors are, for example, known from DE 103 26 154 A1, DE 101 35 848 A1 as well as DE 101 10 753 A1. The vehicle doors disclosed therein comprise a body part on which a plastics sheet is arranged with a sealing bead, which produces the separation between the wet and dry space. The sheet is pressed with the inner lining against the body. In particular the vehicle doors according to DE 101 10 753 A1 and DE 101 35 848 A1 have proved disadvantageous in that a secure seal between the wet and dry space is only provided when comparatively low manufacturing tolerances are maintained. This increases the manufacturing cost considerably.

It is, therefore, the object of the present invention to provide a door lining which does not have the drawbacks of the prior art.

### SUMMARY OF THE INVENTION

The object is achieved by a vehicle door, the interior thereof being subdivided by a separating means into an external wet space facing the body and into an internal dry space facing the door lining and which comprises a sealing region, within which the separating means is clamped between the body and the door lining, at least one spring-like device being arranged in the sealing region.

The vehicle door according to the invention has the advantage that no adhesive bead or sealing bead, with which the separating means is fastened to the door body, has to be arranged on the body side. The door lining may be arranged on the body using standard components. A watertight separation between the wet and dry space is ensured in the door according to the invention. The tasks of the spring-like device include tolerance compensation and as an instrument for controlling the sealing forces and installation forces between the door lining and the body, so that the sealing forces always have a minimum value and the installation forces do not exceed a maximum value. In a preferred embodiment, the separating means and the door lining are already connected to one another before the arrangement thereof on the body. This simplifies the installation and avoids additional handling of the separating means. The separating means and the door lining are combined with one another as a preassembled component. The vehicle door according to the invention is simple and cost-effective to produce.

According to the invention, the vehicle door comprises a body and a door lining. Between the body and the door lining a separating means, preferably a sheet or a sealing mat is arranged, which subdivides the interior of the vehicle door into a wet space and a dry space. In the dry space, electrical components and the like may be arranged which do not tolerate any moisture or are intended to be subjected to as little moisture as possible. The separating means is clamped in a sealing region between the body and the door lining. The clamping ensures the seal of the sealing region.

According to the invention, at least one spring-like device is arranged in the sealing region. It is ensured by said spring-like device that the separating means in the sealing region, independently of all component-dependent manufacturing tolerances provided, is pressed with a defined minimum pressing force against the door body. Moreover, the spring-like device prevents the pressing force from reaching too high a level. The sealing function is implemented as a result of the defined pressing of the separating means against the door body. A peripheral spring-like device may be arranged in the sealing region. The spring element may be dimensioned such that the minimum pressing force is present in the entire sealing region.

The spring-like device may be any means familiar to the person skilled in the art, which has a specific elasticity and which as a result of forces occurring between the door lining and the body, preferably during installation, is only elastically deformed and not plastically-reversibly deformed. The spring-like device ensures that the separating means presses against the body in a defined and sealing manner which is independent of manufacturing tolerances. Preferably, the spring-like device is a common spring known to the person skilled in the art from mechanical engineering and made of plastics or metal. Moreover, the spring-like device may however also be a component, for example a plastics component, which has a cross section which, during installation of the door lining on the body, is elastically deformed and maintains said elasticity. In a further preferred embodiment the spring-like device is a plastics layer which has sufficient elastic properties. In this connection, it is important that even with a large number of load changes, said elasticity is maintained. The elastic component may be configured as a foam bead, preferably in this embodiment a PUR foam bead.

The spring-like device may be arranged on the door lining, either positively and/or non-positively.

In a further preferred embodiment, the spring-like device is arranged on the separating means, perhaps with a material connection.

Preferably, the spring-like device cooperates with a rib-like component, which may be arranged on, or incorporated in, the door lining. The assembly may be arranged with a positive and/or non-positive connection between the spring-like device and the door lining, such as between the rib-like component arranged on the door lining, or incorporated in the door lining.

The separating means may be connected positively and/or non-positively, preferably however releasably, to the door lining via the spring-like device. As a result of said preferred embodiment of the present invention, the door lining and the separating means may be connected to the body as a preassembled component. This simplifies the installation considerably, as separate handling of the separating means is avoided.

Any means is suitable as separating means which is at least substantially watertight and water vapor-tight. Preferably, the separating means is a plastics sheet or a plastics foam mat, although other constructions may be used.

Preferably, the door lining is reversibly arranged on the body by latching means, for example by clip connections.

### BRIEF DESCRIPTION OF THE DRAWINGS

The invention is explained hereinafter with reference to FIGS. 1 to 8. These explanations are given merely by way of example and do not restrict the general inventive idea.

In the drawings:

FIG. 1 shows a vehicle door lining,

FIG. 2 shows the vehicle door lining and the corresponding body in section,

FIG. 3 shows the detail section according to FIGS. 4 to 8, and

FIGS. 4 to 8 show possible embodiments of the sealing region of the vehicle door according to the invention.

### DETAILED DESCRIPTION OF THE PREFERRED EMBODIMENTS

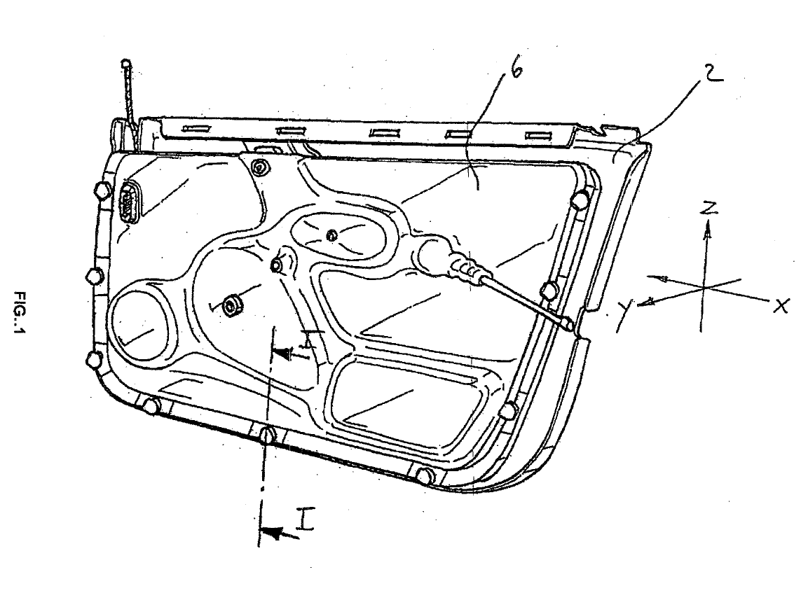

FIG. 1 shows the door lining 2 of the vehicle door according to the invention on which a separating means 6, a scaling sheet, is already installed. Said preassembled subassembly is connected to the body of the vehicle door in a subsequent step. A dry space is produced by the scaling sheet 6, in which all units and electronic components are arranged and thus may be protected from water and/or water vapor.

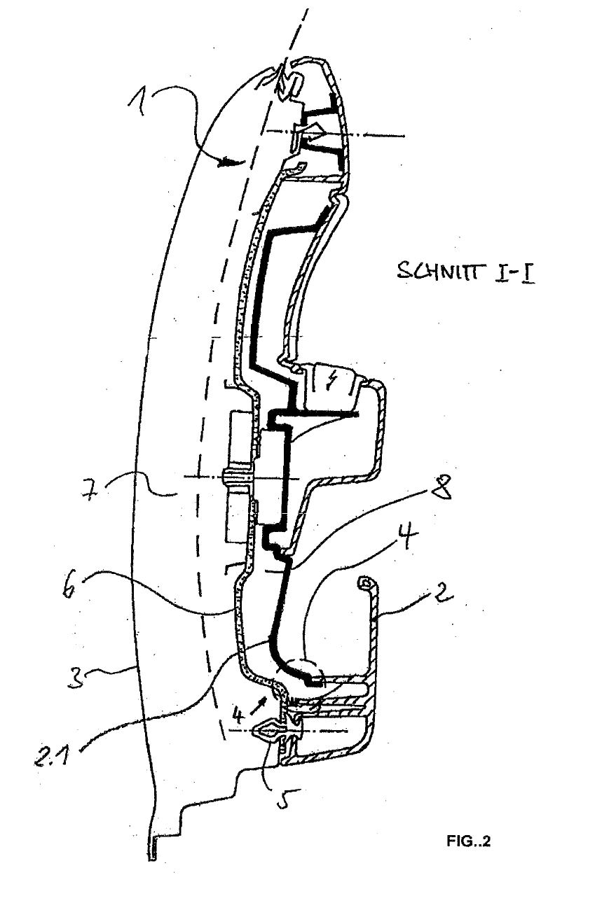

In FIG. 2 a section through a door lining is shown according to FIG. 1, in the present view the body of the door 1 being additionally illustrated. The vehicle door 1 according to the invention consists of a body part 3 as well as a door lining 2, 2.1. Moreover, the vehicle door 1 comprises a separating means 6, in the present case a sealing sheet 6, which subdivides the interior of the vehicle door 1 into a wet space 7 and a dry space 8. The sealing region between the body 3 and the sealing sheet 6 is identified in FIG. 2 by the reference numeral 14. The person skilled in the art understands that the sealing region surrounds the entire door body.

FIG. 3 shows a detailed view of the region outlined in FIG. 2 and identified by the reference numeral 4. A partial region 3.1 of the body 3 may be identified to which the internal door lining 2, 2.1 is fastened by means of a clip 5. Ribs 9 are integrated in the inner door lining 2, one end of a spring 10 being fastened positively and/or non-positively to the tip thereof. The other end of the spring 10 cooperates with the sheet 6 and presses said sheet in the sealing region 14 against the body element 3.1. The spring 10 is constantly pretensioned according to the arrangement of the door lining 2, 2.1 on the body 3, 3.1, so that the sheet 6 is always pressed with a minimum pressure against the body element 3.1 and thus the sealing region 14 is prevented from becoming loose. On the other hand, provided a spring path is still present, the spring 10 prevents the pressing force with which the sheet 6 is pressed against the body element 3.1, from exceeding a maximum value and damaging the sheet 6. Moreover, it is possible that the increase in installation force which is required for fastening the door lining to the body becomes so great as a result of the spring force that installation is no longer possible.

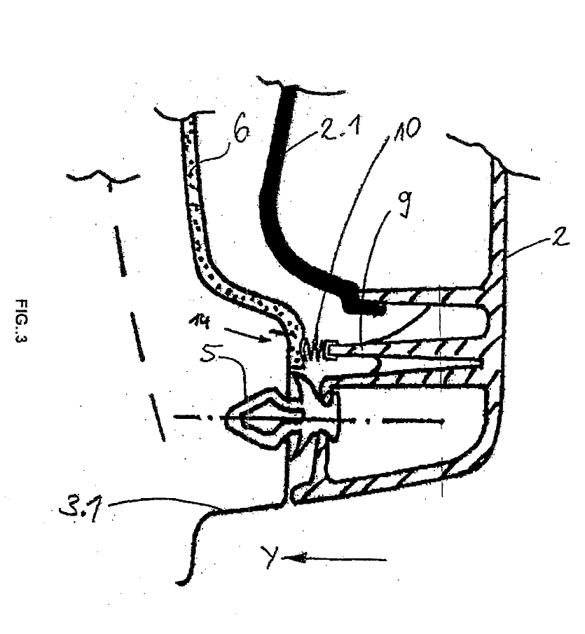

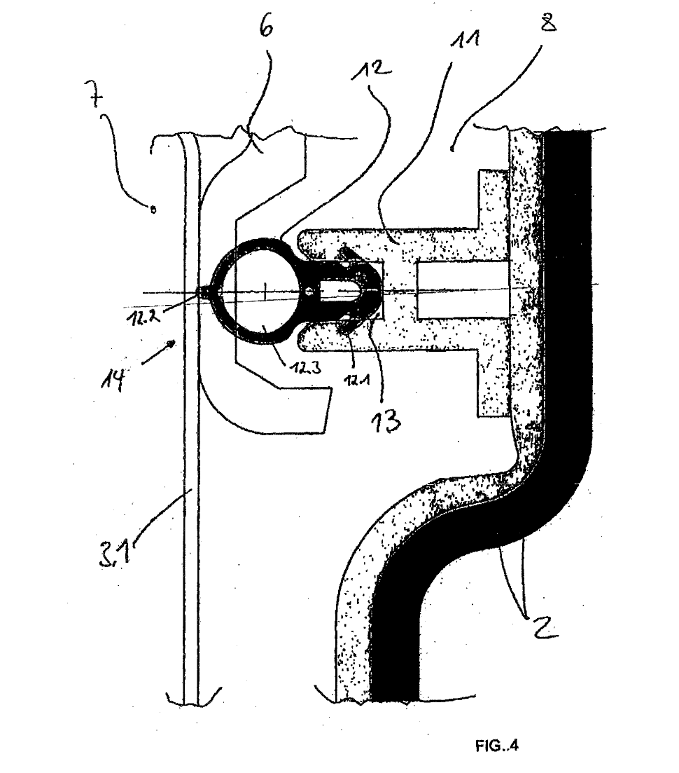

FIG. 4 shows a further embodiment of the vehicle door according to the invention, only the detail 4 according to FIG. 2 being shown. In the present case, the spring-like device 12 is a hollow profile or sealing profile which is arranged in a groove 13 of a pressure rib 11, which in turn is connected to the door lining 2. For the positive and/or non-positive connection between the hollow profile or sealing profile and the groove 13, the profile 12 comprises teeth 12.1 which cooperate with recesses in the groove 13. At the ends opposing the teeth, the spring-like device 12 has a substantially circular hollow region 12.3, at the tip thereof a lip 12.2 being arranged. Both the lip 12.2 and the hollow region 12.3 are elastically deformable and at least the region 12.2 is also elastically deformed to form an ellipse. Said lip 12.2 and parts of the hollow region press the sheet 6 against the body part 3.1. The sealing lip 12.2 allows a linear pressing of the sheet against the body part 3. The material of the sealing profile is EPDM in the present case. During installation, the sealing profile 12 is initially positioned in the groove 13. Subsequently, the sheet 6 is tensioned via the peripheral sealing profile.

Further embodiments of the spring-like device are shown in FIGS. 5 to 8.

In FIG. 5, the spring element is a sealing hollow profile 12, one end thereof cooperating with a groove 13, which is located on a pressure rib 11, positively and/or non-positively. The other end of the sealing profile 12 is, in turn, oval or circular and thus designed to be elastically deformable. Said round, oval region cooperates with the sealing sheet 6 and presses said sheet against the door body (not shown). The part of the sealing profile 12 which cooperates with the groove 13, has teeth (barbs) which prevent the sealing profile from slipping out of the groove.

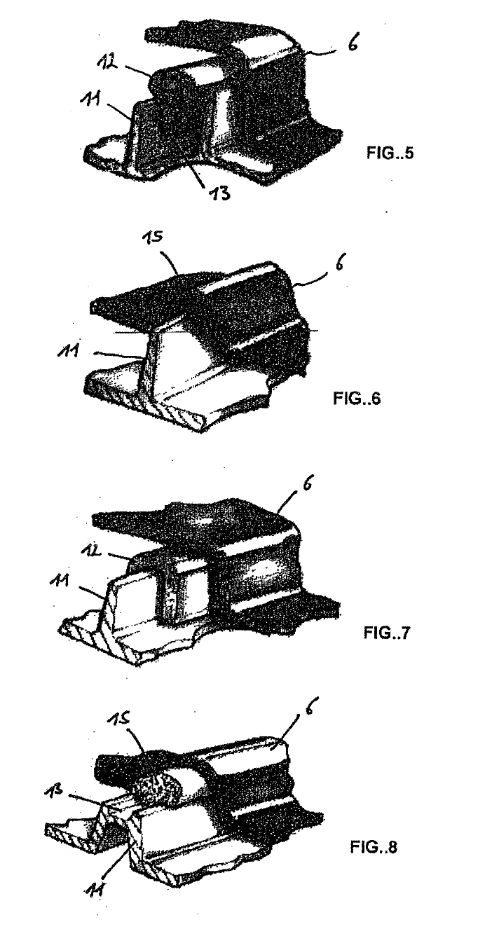

In FIG. 6 the spring element is a foam bead 15 which is arranged with a material connection on the sheet 6. Said foam bead 15 in turn cooperates with a pressure rib 11. The sheet 6 is deep drawn, for example thermoformed, before inserting the foam bead 15. The channel thus formed in the sheet 6 acts in a shaping and/or defining manner during the insertion thereof into the channel. During the installation of the sheet on the pressure rib 11, there is partial guidance between the channel and the pressure rib for positioning via the foam bead.

In the embodiment shown in FIG. 7, the spring element is an elastic plastics profile 12 positioned on a pressure rib 11, which cooperates directly with the sheet 6 and may be connected therewith. The plastics profile is elastically compressed during installation, so that it acts as a spring element.

FIG. 8 shows an embodiment in which the spring element is a foam bead 15, which cooperates positively and/or non-positively, or with a material connection, with a groove 13 which is arranged on a pressure rib 11. Said foam bead, for example PUR foam, is also compressed during installation and thus presses the sheet 6 against the body part 3, 3.1.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

### LIST OF REFERENCE NUMERALS

1 Vehicle door
2 Door lining
2.1 Door lining, internal wall
3 Body
3.1 Body, inner panel
4 Sealing zone
5 Clip
6 Separating means, sheet
7 Wet space
8 Dry space
9 Pressure rib
10 Spring element
11 Pressure rib
12 Sealing profile
12.1 Teeth
12.2 Lip
12.3 Hollow region
13 Groove
14 Scaling region
15 Foam bead

1. A vehicle door (1), the interior thereof being subdivided by a separating means (6) into an external wet space (7) facing the body (3) and into an internal dry space (8) facing the door lining (2, 2.1) and which comprises a sealing region (14), within which the separating means (6) is clamped between the body (3) and the door lining (2, 2.1), characterized in that at least one spring means (10, 12, 15) is arranged in the sealing region (14).

2. The vehicle door as claimed in claim 1, further characterized in that the spring means (10, 12, 15) is arranged on the door lining (2, 2.1).

3. The vehicle door as claimed in claim 1, further characterized in that the spring means (10, 12, 15) is arranged on the separating means (6).

4. The vehicle door as claimed in claim 1, further characterized in that the spring means (10, 12, 15) cooperates with a rib-like component (9, 11) of the door lining (2, 2.1).

5. The vehicle door as claimed in claim 1, further characterized in that the separating means (6) is connected to the door lining via the spring means (10, 12, 15).

6. The vehicle door as claimed in claim 1, further characterized in that the separating means (6) is a plastics sheet or a scaling mat.

7. The vehicle door (1) as claimed in claim 1, further characterized in that the door lining (2, 2.1) is arranged on the body (3) by latching means (5).
